(19) United States
(12) Patent Application Publication
(10) Pub. No.: US 2007/0196612 A1
(43) Pub. Date: Aug. 23, 2007

(54) Liquid epoxy resin composition

(75) Inventor: Kazumasa Igarashi, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION, Osaka (JP)

(21) Appl. No.: 11/596,414

(22) PCT Filed: May 10, 2005
(86) PCT No.: PCT/JP05/08525

§ 371 Date: Nov. 13, 2006

(30) Foreign Application Priority Data
May 11, 2004 (JP) 2004-141586
Dec. 9, 2004 (JP) 2004-357099

(51) Int. Cl. B32B 33/00

(52) U.S. Cl. 428/41.3; 428/41.5

(57) ABSTRACT

There is provided a low viscosity liquid epoxy resin composition which has excellent repairability because of the capability to remove residues at around room temperature even in the case of an electronic part device having a deficiency in the electric connection after once carrying out underfill, and what is more, wherein an electric parts device having a connected mounted structure shows high reliability. The liquid epoxy resin composition is used for resin-filling the gap between a circuit substrate and a semiconductor part on an electronic part device, wherein said electronic part device comprises a circuit substrate having an electrode part for connection and a semiconductor part having an electrode part for connection and being mounted on the circuit substrate in such a way that the electrode part of the circuit substrate and the electrode part of the semiconductor part are facing each other. In addition, the liquid epoxy resin composition comprises the following components (A) to (C) together with the following component (D). (A) A liquid epoxy resin. (B) An aromatic diamine curing agent. (C) An inorganic filler. (D) An organic additive.

### TECHNICAL FIELD

The present invention relates to a liquid epoxy resin composition which is used in resin-encapsulation by filling the gap between a semiconductor part and a circuit substrate, in a flip chip connecting method in which facing electrodes of a semiconductor part and a circuit substrate are electrically connected via an electrode for connection (bump) of a semiconductor package such as BGA (ball grid array), CSP (chip scale package or chip size package) or the like or a semiconductor part such as a semiconductor element or the like.

### BACKGROUND OF THE INVENTION

In recent years, BGA, CSP and the like semiconductor packages are mounted with high density on printed wiring substrates. In the past, sufficient reliability had been maintained for the mounting of such a semiconductor package having array type bump electrodes, without carrying out resin encapsulation for the stress dispersion and mechanical reinforcement by underfill or the like, because of the wide inter-bump connection pitch and large metal bumps for connection. However, since the bump electrodes became narrow-pitched and small in recent years, underfill or the like reinforcement by a resin is carried out.

On the other hand, a direct chip attachment system using a bear chip such as a semiconductor element flip chip or the like is drawing attention. As this flip chip system connection method, a method so-called “C4 technique” is famous, in which a high melting point solder bump is formed on the chip side, and its inter-metal connection with solder of a ceramic circuit substrate is carried out.

However, when a resin system substrate such as a printed circuit substrate made of glass-epoxy resin or the like is used instead of the ceramics circuit substrate, it causes a problem in that its connection reliability becomes insufficient because of the destruction of the solder bump connection part caused by the difference in coefficient of thermal expansion between the chip and the resin system substrate. As a measure against such a problem, it became general to carry out a technique so-called underfill in which gap between the semiconductor element and resin system circuit substrate is filled, for example, using a liquid resin composition, for the dispersion of thermal stress and thereby to improve the reliability.

However, since a thermosetting resin composition containing of an epoxy resin or the like as the main component is generally used as the liquid resin composition to be used in the aforementioned underfill, there is a problem in that it cannot be easily repaired after curing by heating, because the product does not melt, has high adhesiveness, does not decompose, is insoluble in solvents and the like. Accordingly, once the underfill is carried out, for example, an electronic part device having a deficiency in electric connection must be scrapped and discarded. This means that it is necessary to avoid discharge of waste to the utmost, because recycling ability is in demand in recent years toward the global environmental conservation, and it is expected that repairing can be made even after the underfill.

As such a repairable liquid epoxy resin composition, an adhesive for electronic parts connection has been disclosed, which uses an epoxy resin as the main material, a capsule type curing agent coated with a thermoplastic resin as the curing agent, and an acrylic resin as the repairability providing agent (cf. Patent Reference 1).

Also, an adhesive which comprises a thermosetting resin, a thermoplastic resin such as polymethyl methacrylate, an inorganic filler and a coupling agent has been disclosed (cf. Patent Reference 2).

In addition, a repairable thermosetting resin composition which comprises an epoxy resin, a curing agent and a plasticizer has been disclosed (cf. Patent Reference 3). However, influences of the cured product upon glass transition temperature and the like physical properties, which are important for the reliability of the connected mounted structure, are not described.
Patent Reference 1: JP-A-7-102225
Patent Reference 2: JP-A-2001-81439
Patent Reference 3: JP-A-10-204259

### DISCLOSURE OF THE INVENTION

Problems that the Invention is to Solve However, it is hard to say that the adhesive for electronic parts connection described in the aforementioned Patent Reference 1 is suitable for the fluidity as underfill due to its thixotropy, because it is desirable that an underfill has such a fluidity characteristic that shear rate-dependency is not found. Also, it is hard to say that the adhesive described in the aforementioned Patent Reference 2 which has been uniformly stirred and mixed can achieve low viscosity required for underfill, because viscosity generally becomes high in response to the molecular weight of thermoplastic resin so that the viscosity becomes high after mixing with an inorganic filler for the purpose of reducing coefficient of linear expansion of the cured material. Also, the aforementioned thermoplastic resin aims at reducing glass transition temperature or softening point of the cured material for the purpose of improving easiness for the removal of electronic parts by heating, so that this is not described from the viewpoint of keeping glass transition temperature for ensuring connection reliability. In addition, the thermosetting resin composition described in the aforementioned Patent Reference 3 is insufficient as an adhesive material for underfill use, because influences of the cured product upon glass transition temperature and the like physical properties, which are important for the reliability of the connected mounted structure, are not described.

The present invention has been made by taking such circumstances into consideration, and an object thereof is to provide a low viscosity liquid epoxy resin composition which has excellent repairability because of the capability to remove residues at around room temperature even in the case of an electronic part device having a deficiency in the electric connection after once carrying out underfill, and what is more, wherein an electric parts device as a connected mounted structure shows high reliability.

Means for Solving the Problems

In order to achieve the aforementioned object, the liquid epoxy resin composition of the present invention is a liquid epoxy resin composition to be used for filling the gap between a circuit substrate and a semiconductor part of an electronic part device,

wherein said electronic part device comprises a circuit substrate having an electrode part for connection and a semiconductor part having an electrode part for connection and being mounted on the circuit substrate in such a way that the electrode part of the circuit substrate and the electrode part of the semiconductor part are facing each other,

which comprises the following components (A) to (C) and the following component (D):

(A) a liquid epoxy resin,

(B) an aromatic diamine curing agent,

(C) an inorganic filler,

(D) an organic additive.

With the aim of achieving the aforementioned object, the inventors have conducted studies on an epoxy resin composition as the underfill material for resin-encapsulating the gap between a circuit substrate and a semiconductor part (a semiconductor device, a semiconductor element or the like). Previously, the inventors have found that a specific epoxy resin composition cured material causes salvation and subsequent swelling by a specific solvent, and as a result, reduction of coat strength of the cured material as the filling resin and reduction of adhesive strength occur, thus rendering possible mechanical peeling of the cured material and making it possible to repair a semiconductor element (flip chip) (JP-A-2003-119251). That is, a specific fluorine-containing aromatic diamine as a curing agent reduces solubility parameter (SP) value of the cured material due to its trifluoromethyl substituent or fluorine substituent, so that the repairability is exhibited by the aptness of the specific solvent to cause solvation and subsequent swelling.

Thereafter, it was found according to the present invention that more superior repairability-improving effect can be obtained by the joint use of an organic additive. That is, with the aim of achieving the aforementioned object, the inventors have conducted extensive studies on an epoxy resin composition as the underfill material for resin-filling the gap between a circuit substrate and a semiconductor part. It was found as a result that when an organic additive [component (D)] is formulated together with the aforementioned components (A) to (C), a specific solvent causes salvation and subsequent swelling of a cured material of this epoxy resin composition, and as a result, reduction of coat strength of the cured material as the filling resin and reduction of adhesive strength occur, thus enabling mechanical peeling of the cured material and enabling easier repair of semiconductor parts such as easy removal of resin residues remained on the circuit substrate at room temperature or the like, thus reaching the present invention.

That is, the present invention includes the following embodiments.

1. A liquid epoxy resin composition to be used for filling the gap between a circuit substrate and a semiconductor part of an electronic part device,

wherein said electronic part device comprises a circuit substrate having an electrode part for connection and a semiconductor part having an electrode part for connection and being mounted on the circuit substrate in such a way that the electrode part of the circuit substrate and the electrode part of the semiconductor part are facing each other,

which comprises the following components (A) to (C) and the following component (D):

(A) a liquid epoxy resin,

(B) an aromatic diamine curing agent,

(C) an inorganic filler,

(D) an organic additive.

2. The liquid epoxy resin composition described in the aforementioned 1, wherein the aromatic diamine curing agent as the aforementioned component (B) is at least one of an aromatic diamine represented by the following general formula (1) and derivatives thereof 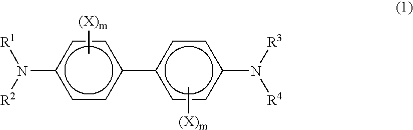
[in the formula (1), X is hydrogen and/or CₙH₂ₙ₊₁ (n is a positive number of from 1 to 10), m is a positive number of from 1 to 4, and R¹ to R⁴ may be the same or different from one another and each is hydrogen or a monovalent organic group].

3. The liquid epoxy resin composition described in the aforementioned 1, wherein the aromatic diamine curing agent as the aforementioned component (B) is at least one of a fluorine-containing aromatic diamine represented by the following general formula (2) and derivatives thereof 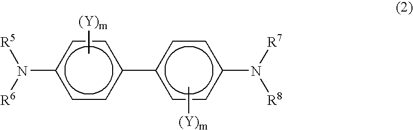
[in the formula (2), Y is fluorine and/or CₙF₂₊₁ (n is a positive number of from 1 to 10), m is a positive number of from 1 to 4, and R⁵ to R⁸ may be the same or different from one another and each is hydrogen or a monovalent organic group].

4. The liquid epoxy resin composition described in the aforementioned 1, wherein the aromatic diamine curing agent as the aforementioned component (B) is a reaction product of a monoepoxy compound containing one epoxy group in one molecule with 2,2′-ditrifluoromethyl-4,4′-diaminobiphenyl.

5. The liquid epoxy resin composition described in the aforementioned 4, wherein the aforementioned monoepoxy compound containing one epoxy group in one molecule is at least one compound selected from the group consisting of n-butyl glycidyl ether, allyl glycidyl ether, 2-ethylhexyl glycidyl ether, styrene oxide, phenyl glycidyl ether, cresyl glycidyl ether, lauryl glycidyl ether, p-sec-butylphenyl glycidyl ether, nonylphenyl glycidyl ether, glycidyl ether of carbinol, glycidyl methacrylate, vinylcyclohexene monoepoxide and α-pinene oxide.

6. The liquid epoxy resin composition described in the aforementioned 2, which comprises a prepolymer prepared by allowing at least one of an aromatic diamine represented by the aforementioned general formula (1) and derivatives thereof to react with a liquid epoxy resin as the component (A).

7. The liquid epoxy resin composition described in the aforementioned 3, wherein it comprises a prepolymer prepared by allowing at least one of a fluorine-containing aromatic diamine represented by the aforementioned general formula (2) and derivatives thereof to react with a liquid epoxy resin as the component (A).

8. The liquid epoxy resin composition described in any one of the aforementioned 1 to 7, wherein the inorganic filler as the aforementioned component (C) is a spherical silica powder having an average particle diameter of 10 μm or less.

9. The liquid epoxy resin composition described in any one of the aforementioned 1 to 7, wherein the inorganic filler as the aforementioned component (C) is a spherical silica powder having an average particle diameter of 10 μm or less, wherein the surface thereof is coated with an organic silane compound represented by the following general formula (3)
(α¹—O)ₐ—Si—(β¹)_{b} (3)
[in the formula (3), α¹ is a monovalent organic group other than hydrogen, β¹ is a monovalent organic group containing at least one amino group, epoxy group, vinyl group, styryl group, methacryloxy group or ureido group, and a and b are a+b=4 and each is a positive number of 1 to 3].

10. The liquid epoxy resin composition described in the aforementioned 9, wherein the organic silane compound represented by the aforementioned general formula (3) is an organic silane compound represented by the following general formula (4)
(α¹—O)₃—Si—γ—NH₂ (4)
[in the formula (4), α¹ is a monovalent organic group other than hydrogen, and γ is a divalent organic group].

11. The liquid epoxy resin composition described in any one of the aforementioned 1 to 7, wherein the inorganic filler as the aforementioned component (C) is a spherical silica powder having an average particle diameter of 10 μm or less, wherein the surface thereof is coated with an organic titanium compound represented by the following general formula (5)
(α¹—O)ₐ—Ti—(β¹)_{b} (5)
[in the formula (5), α¹ is a monovalent organic group other than hydrogen, β¹ is a monovalent organic group containing at least one amino group, epoxy group, vinyl group, styryl group, methacryloxy group or ureido group, and a and b are a+b=4 and each is a positive number of 1 to 3].

12. The liquid epoxy resin composition described in any one of the aforementioned 1 to 11, wherein the organic additive as the aforementioned component (D) is at least one of a spherical thermoplastic resin particle having an average particle diameter of 10 μm or less and a spherical crosslinked resin particle having an average particle diameter of 10 μm or less.

13. The liquid epoxy resin composition described in the aforementioned 12, wherein at least one of the aforementioned spherical thermoplastic resin particle and spherical crosslinked resin particle is a spherical polymethyl methacrylate particle.

14. The liquid epoxy resin composition described in the aforementioned 13, wherein weight average molecular weight of the aforementioned spherical polymethyl methacrylate particle is within the range of from 100,000 to 5,000,000.

15. The liquid epoxy resin composition described in the aforementioned 13, wherein the aforementioned spherical polymethyl methacrylate particle is a spherical crosslinked polymethyl methacrylate particle having a glass transition temperature of 100° C. or more.

16. The liquid epoxy resin composition described in any one of the aforementioned 1 to 15, wherein the aforementioned semiconductor part is a semiconductor element.

17. The liquid epoxy resin composition described in any one of the aforementioned 1 to 15, wherein the aforementioned semiconductor part is a semiconductor device.

### ADVANTAGE OF THE INVENTION

Thus, the present invention is a liquid epoxy resin composition which is used for resin-encapsulation the gap between a circuit substrate and a semiconductor part and contains an organic additive [component (D)] together with the aforementioned components (A) to (C). Because of this, the aforementioned liquid epoxy resin composition has a low viscosity, does not generate voids when filled, and can easily show solvation and swelling by a specific organic solvent at room temperature even after its curing. As a result, strength of the cured body is markedly reduced, thus rendering possible its easy peeling from an adherend (electrode or the like). Accordingly, an electron part device obtained by resin-encapsulation using the liquid epoxy resin composition of the present invention has excellent connection reliability, and even when connection defect occures due to misregistration between electrodes or the like, an electronic part device equipped with excellent repairability can be obtained without discarding the electronic parts device itself.

Also, use of an aromatic diamine represented by the following general formula (1) and a derivative thereof or a fluorine-containing aromatic diamine represented by the following general formula (2) and a derivative thereof as the aforementioned aromatic diamine curing agent [component (B)] is preferable, because it exerts a desirable effect that easy repairability due to quick swelling ability is exhibited.

Also, when a reaction product of a monoepoxy compound containing one epoxy group in one molecule with 2,2′-ditrifluoromethyl-4,4′-diaminobiphenyl is used as the aforementioned aromatic diamine curing agent [component (B)], salvation and swelling property are improved and good repairing becomes possible.

Also, when a prepolymer prepared by using at least one of an aromatic diamine represented by the following general formula (1) and derivatives thereof or at least one of a fluorine-containing aromatic diamine represented by the following general formula (2) and derivatives thereof and allowing this to react with a liquid epoxy resin [component (A)] is used as the aforementioned aromatic diamine curing agent [component (B)], still more improvement of the curing rate is possible. Moreover, since it can be formed into a state of from a liquid form to a viscous paste form, a liquid epoxy resin composition can be easily obtained without requiring complex steps for the weighing at the time of formulation and subsequent dispersion step.

Further, when a spherical silica powder having a specific average particle diameter, wherein the surface is coated with a specific organic silane compound or a specific organic titanium compound, is used as the aforementioned inorganic filler [component (C)], it exerts such an effect that viscosity of the blend can be reduced or its thixotropy can be reduced.

In addition, when at least one of a spherical thermoplastic resin particle having a specific particle diameter and a spherical crosslinked resin particle having a specific particle diameter is used as the aforementioned organic additive [component (D)], it exerts such an effect that a filling material which can be sufficiently injected and filled into the narrow gap between a semiconductor part and a resin system circuit substrate is obtained.

### BRIEF DESCRIPTION OF THE DRAWINGS

FIG. 1 is a sectional view schematically showing an example of the electronic part device of the present invention.

FIG. 2 is a sectional view schematically showing another example of the electronic part device of the present invention.

### DESCRIPTION OF THE REFERENCE NUMERALS

1 Semiconductor element (flip chip)
2, 12 Wiring circuit substrate
3 Electrode part for connection of the semiconductor element (solder bump)
4, 14 Filling resin layer
5, 15 Electrode part for connection of the wiring circuit substrate (solder bump)
11 Semiconductor device (semiconductor package)
13 Electrode part for connection of the semiconductor device (solder bump)

### BEST MODE FOR CARRYING OUT THE INVENTION

The liquid epoxy resin composition of the present invention is obtained by formulating an organic additive (component D) together with a liquid epoxy resin (component A), an aromatic diamine curing agent (component B) and an inorganic filler (component C). In this connection, the liquid according to the liquid epoxy resin composition of the present invention means a liquid which shows fluidity at 25° C. That is, it has a viscosity of within the range of from 0.01 mPa·s to 10000 Pa·s at 25° C. Measurement of the aforementioned viscosity can be carried out, for example, by using an EMD type rotational viscometer.

The aforementioned liquid epoxy resin (component A) is not particularly limited, with the proviso that it is a liquid epoxy resin containing two or more epoxy groups in one molecule, and its examples include bisphenol A type, bisphenol F type, hydrogenated bisphenol A type, bisphenol AF type, phenol novolak type and the like various liquid epoxy resins and derivatives thereof, liquid epoxy resins derived from a polyhydric alcohol and epichlorohydrin and derivatives thereof, glycidyl amine type, hydantoin type, aminophenol type, aniline type, toluidine type and the like various glycidyl type liquid epoxy resins and derivatives thereof (described on page 211 to page 225 of “Jitsuyo Plastic Jiten Zairyo Hen (Practical Plastics Dictionary, A Chapter on Materials)”, published by Jitsuyo Plastic Jiten Henshu Iinkai (Practical Plastics Dictionary Editorial Committee), the first edition, third printing, published on Apr. 20, 1996), and liquid mixtures of these aforementioned liquid epoxy resins with various glycidyl type solid epoxy resins and the like. These may be used alone or as a combination of two or more.

The aforementioned aromatic diamine curing agent (component B) exerts an action to cure the aforementioned liquid epoxy resin (component A), and it is desirable to use at least one of an aromatic diamine and derivatives thereof, but it is more desirable to use at least one of a fluorine-containing aromatic diamine and derivatives thereof from the viewpoint that it induces easy solvation and subsequent swelling by a specific solvent.

Examples of the aromatic diamine in the aforementioned at least one of an aromatic diamine and derivatives thereof, p-phenylenediamine, m-phenylenediamine, 2,5-toluenediamine, 2,4-toluenediamine, 4,6-dimethyl-m-phenylenediamine, 2,4-diaminomesitylene and the like aromatic mononuclear diamines, 4,4′-diaminodiphenyl ether, 3,3′-diaminodiphenyl ether, 3,4′-diaminodiphenyl ether, 4,4′-diaminodiphenylmethane, 3,3′-diaminodiphenylmethane, 4,4′-diaminodiphenylsulfone, 3,3′-diaminodiphenylsulfone, 4,4′-diaminodiphenyl sulfide, 3,3′-diaminodiphenyl sulfide, 4,4′-diaminobenzophenone, 3,3′-diaminobenzophenone and the like aromatic dinuclear diamines, 1,4-bis(4-aminophenoxy)benzene, 1,4-bis(3-aminophenoxy)benzene, 1,3-bis(4-aminophenoxy)benzene, 1,3-bis(3-aminophenoxy)benzene and the like aromatic trinuclear diamines, 4,4′-di-(4-aminophenoxy)diphenylsulfone, 4,4′-di-(3-aminophenoxy)diphenylsulfone, 4,4′-di-(4-aminqphenoxy)diphenylpropane, 4,4′-di-(3-aminophenoxy)diphenylpropane, 4,4′-di-(4-aminophenoxy)diphenyl ether, 4,4′-di-(3-aminophenoxy)diphenyl ether and the like aromatic tetranuclear diamines and the like, and these may be used alone or as a combination of two or more.

Particularly, from the viewpoint of prolonging pot life at room temperature, it is desirable to use at least one of an aromatic diamine represented by the following general formula (1) and derivatives thereof as the aforementioned aromatic diamine curing agent (component B). 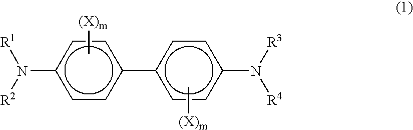
[In the formula (1), X is hydrogen and/or CₙH₂ₙ₊₁ (n is a positive number of from 1 to 10), m is a positive number of from 1 to 4, and R¹ to R⁴ may be the same or different from one another and each is hydrogen or a monovalent organic group.]

In the aforementioned formula (1), R¹ to R⁴ are hydrogen or a monovalent organic group. As the aforementioned monovalent organic group, for example, a saturated alkyl group represented by —CₙH₂ₙ₊₁ (n is a positive number of from 1 to 10), an aryl group, a 3-alkoxy substituted-2-hydroxypropyl group represented by —CH₂CH(OH)CH₂—OCₙH₂ₙ₊₁, a 3-aryl substituted-2-hydroxypropyl group represented by —CH₂CH(OH)CH₂—O—R⁹ (R⁹ is an aryl group) and the like may be cited. In this regard, the aforementioned R¹ to R⁴ may be the same or different from one another.

The fluorine-containing aromatic diamine as the aforementioned at least one of a fluorine-containing aromatic diamine and derivatives thereof is not particularly limited with the proviso that it is a fluorine-substituted aromatic diamine having a primary amino group, and its examples include 2,2′-ditrifluoromethyl-4,4′-diaminobiphenyl, 2,2-bis(4-aminophenyl)hexafluoropropane, 2,2-bis(3-amino-4-methylphenyl)hexafluoropropane, 2,2-bis(3-amino-4-hydroxyphenyl)hexafluoropropane, 2,2-bis[4-(4-aminophenoxy)phenyl]hexafluoropropane, 2,2-bis(3-amino-4,5-dimethylphenyl)hexafluoropropane, 2,2-bis(4-hydroxy-3-aminophenyl)hexafluoropropane, 4,4′-bis[2-(4-carboxyphenyl)hexafluoroisopropyl]diphenyl ether, 4,4′-bis[2-(4-aminophenoxyphenyl)hexafluoroisopropyl]diphenyl ether and the like, wherein these may be used alone or as a combination of two or more.

Particularly, from the viewpoint of prolonging pot life at room temperature, it is desirable to use at least one of a fluorine-containing aromatic diamine represented by the following general formula (2) and derivatives thereof as the aforementioned aromatic diamine curing agent (component B). 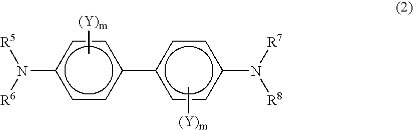
[In the formula (2), Y is fluorine and/or CₙH₂ₙ₊₁ (n is a positive number of from 1 to 10), m is a positive number of from 1 to 4, and R⁵ to R⁸ may be the same or different from one another and each is hydrogen or a monovalent organic group.]

In the aforementioned formula (2), R⁵ to R⁸ are hydrogen or a monovalent organic group. As the aforementioned monovalent organic group, for example, a saturated alkyl group represented by —CₙH₂ₙ₊₁ (n is a positive number of from 1 to 10), an aryl group, a 3-alkoxy substituted-2-hydroxypropyl group represented by —CH₂CH(OH)CH₂—OCₙH₂ₙ₊₁, a 3-aryl substituted-2-hydroxypropyl group represented by —CH₂CH(OH)CH₂—O—R¹⁰ (R¹⁰ is an aryl group) and the like can be cited. In addition, R⁵ to R⁸ may be the same or different from one another.

Particularly, according to the present invention, it is desirable to use 2,2′-ditrifluoromethyl-4,4′-diaminobiphenyl having the most small active hydrogen equivalent, or p-phenylenediamine or m-phenylenediamine also having the most small active hydrogen equivalent, as the aforementioned aromatic diamine curing agent (component B), from the viewpoint that the blending quantity can be lessened and viscosity of the one-component non-solvent epoxy resin composition can be reduced.

In addition, a reaction product of the aforementioned fluorine-containing aromatic diamine, particularly 2,2′-ditrifluoromethyl-4,4′-diaminobiphenyl, with a monoepoxy compound containing one epoxy group in one molecule is suitably used as the aforementioned aromatic diamine curing agent (component B), from the viewpoint that salvation and swelling property are improved and good repair becomes possible. The reaction of the aforementioned fluorine-containing aromatic diamine with a monoepoxy compound containing one epoxy group in one molecule is generally carried out without a catalyst, by putting predetermined amounts of respective components in a reaction container, and carrying out the reaction in a stream of nitrogen by heating at approximately from 60 to 120° C. until epoxy group is consumed. In this manner, for example, an N,N,N′,N′-4 substituted fluorine-containing aromatic diamine compound is obtained.

The aforementioned monoepoxy compound is not particularly limited with the proviso that it is an epoxy compound containing one epoxy group in one molecule, and its examples include n-butyl glycidyl ether, allyl glycidyl ether, 2-ethylhexyl glycidyl ether, styrene oxide, phenyl glycidyl ether, cresyl glycidyl ether, lauryl glycidyl ether, p-sec-butylphenyl glycidyl ether, nonylphenyl glycidyl ether, glycidyl ether of carbinol, glycidyl methacrylate, vinylcyclohexene monoepoxide, a-pinene oxide and the like.

Regarding the blending ratio of the liquid epoxy resin (component A) with the aromatic diamine curing agent (component B) according to the present invention, it is desirable to set the number of active hydrogen of the aforementioned aromatic diamine curing agent (component B) to a range of from 0.4 to 1.6 based on 1 epoxy group of the aforementioned liquid epoxy resin (component A). More preferred is a range of from 0.6 to 1.2. That is, this is because viscosity of the liquid epoxy resin composition tends to increase when the number of active hydrogen exceeds 1.6 based on 1 epoxy group, and glass transition temperature of cured body of the liquid epoxy resin composition tends to decrease when less than 0.4.

On the other hand, according to the present invention, when the aforementioned liquid epoxy resin (component A), particularly a multifunctional aliphatic epoxy resin, is used, a possibility of generating voids caused by the vaporization and volatilization of low boiling point compounds contained in the multifunctional aliphatic epoxy resin and the like can be reduced by preparing a prepolymer through a preliminary reaction of at least one of an aromatic diamine represented by the aforementioned general formula (1) and derivatives thereof, or at least one of a fluorine-containing aromatic diamine represented by the aforementioned general formula (2) and derivatives thereof, with the multifunctional aliphatic epoxy resin.

The aforementioned prepolymer is obtained, for example, by allowing at least one of an aromatic diamine represented by the aforementioned general formula (1) and derivatives thereof, or at least one of a fluorine-containing aromatic diamine represented by the aforementioned general formula (2) and derivatives thereof, to react with a multifunctional aliphatic liquid epoxy compound having two or more epoxy groups in one molecule. In general, the prepolymer is prepared without a catalyst, by putting predetermined amounts of respective components in a reaction container, and carrying out the reaction in a stream of nitrogen by heating at approximately from 60 to 120° C. until a predetermined molecular weight is obtained. Regarding the molecular weight of this prepolymer, it is desirable to use a prepolymer obtained by carrying out the reaction until its polystyrene-based weight average molecular weight became approximately from 400 to 5000, because the use of such a prepolymer renders possible prevention of the generation of voids in the underfill filling resin layer caused by the vaporization and volatilization of volatile low boiling point low molecular weight compounds.

Illustrative examples of the aforementioned multifunctional aliphatic liquid epoxy resin include ethylene glycol diglycidyl ether, propylene glycol diglycidyl ether, butanediol diglycidyl ether, neopentyl glycol diglycidyl ether, diglycidylaniline, trimethylolpropane diglycidyl ether, trimethylolpropane triglycidyl ether, glycerol diglycidyl ether, glycerol triglycidyl ether or the like aliphatic diol or triol, or a multifunctional glycidyl ether of an aliphatic multifunctional alcohol or the like.

In addition, according to the present invention, conventionally known various curing accelerators can be used for the purpose of shortening the curing time. Illustratively, salicylic acid or the like acidic catalyst, copper acetylacetonate, zinc acetylacetonate or the like Lewis acid and the like may be exemplified. These are used alone or as a combination of two or more.

Blending amount of the aforementioned curing accelerator is not particularly limited, but it is desirable to optionally set it to such a ratio that desired curing rate is obtained based on the mixture of the aforementioned liquid epoxy resin (component A) and aromatic diamine curing agent (component B). For example, its amount to be used can be easily decided while measuring the gelling time, as the index of curing rate, on a hot plate. As an example thereof, it is desirable to set it to a range of from 0.01 to 3% by weight based on the whole liquid epoxy resin composition.

As the inorganic filler (component C) to be used together with the aforementioned liquid epoxy resin (component A) and aromatic diamine curing agent (component B), synthetic silica, fused silica and the like silica powders and alumina, silicon nitride, aluminum nitride, boron nitride, magnesia, calcium silicate, magnesium hydroxide, aluminum hydroxide, titanium oxide and the like various powders may be exemplified. Among the aforementioned inorganic fillers, the use of spherical silica powder is particularly desirable because of the large effect to reduce viscosity of the liquid epoxy resin composition. In addition, regarding the aforementioned inorganic filler, it is desirable to use a substance having a maximum particle diameter of 24 μm or less. Further, in addition to the aforementioned maximum particle diameter, a substance having an average particle diameter of 10 μm or less is desirably used, particularly, a substance having an average particle diameter of from 1 to 5 μm is suitably used. In addition, it is desirable to use an inorganic filler having a specific surface area of 1 to 4 m²/g by the BET method. In this connection, the aforementioned maximum particle diameter and average particle diameter can be measured, for example, using a laser diffraction scattering type particle size distribution analyzer.

In addition, regarding the aforementioned inorganic filler (component C), suitably, it is desirable to use spherical silica particles in which each surface is coated with an organic silane compound represented by the following general formula (3) having an average particle diameter of 10 μm or less, particularly preferably the aforementioned surface-coated spherical silica particles having an average particle diameter of from 1 to 5 μm.
(α¹—O)ₐ—Si—(β¹)_{b} (3)
[In the formula (3), α¹ is a monovalent organic group other than hydrogen, β¹ is a monovalent organic group containing at least one amino group, epoxy group, vinyl group, styryl group, methacryloxy group or ureido group, and a and b are a+b=4 and each is a positive number of 1 to 3.]

Among the spherical silica particles in which each surface is coated with an organic silane compound represented by the following general formula (3) having an average particle diameter of 10 μm or less, spherical silica particles in which each surface is coated with an aminosilane coupling agent represented by the following general formula (4) having an average particle diameter of 10 μm or less are used, of which particularly preferred are spherical silica particles having an average particle diameter of from 1 to 5 μm. Thus, by coating the surface of spherical silica particle using the aforementioned aminosilane coupling agent, improvement of dispersibility and reduction of viscosity can be effected by the interaction of wettability or the like with the liquid epoxy resin (component A) or the like.
(α¹—O)₃—Si—γ—NH₂ (4)
[In the formula (4), α¹ is a monovalent organic group other than hydrogen, and γ is a divalent organic group.]

As the organic silane compound represented by the aforementioned general formula (3), for example, N-2(aminoethyl)-3-aminopropyl-methyldimethoxysilane, N-2(aminoethyl)-3-aminopropyl-triethoxysilane, N-2(aminoethyl)-3-aminopropyl-trimethoxysilane, 3-aminopropyltrimethoxysilane, 3-aminopropyltriethoxysilane and the like can be cited. These are used alone or as a combination of two or more.

On the other hand, spherical silica particles in which each surface is coated with an organic titanium compound represented by the following general formula (5) having an average particle diameter of 10 μm or less are preferably used as the aforementioned inorganic filler (component C), of which particularly preferred are the aforementioned surface-coated spherical silica particles having an average particle diameter of from 1 to 5 μm.
(α¹—O)ₐ—Ti—(β¹)_{b} (5)
[In the formula (5), α¹ is a monovalent organic group other than hydrogen, β¹ is a monovalent organic group containing at least one amino group, epoxy group, vinyl group, styryl group, methacryloxy group or ureido group, and a and b are a+b=4 and each is a positive number of 1 to 3.]

As the organic titanium compound represented by the aforementioned general formula (5), for example, isopropyltriisostearoyl titanate, isopropyltris(dioctyl pyrophosphate)titanate, isopropyltris(dioctyl pyrophosphate)titanate, isopropyltri(N-aminoethyl-aminoethyl)titanate, tetraoctylbis(ditridecyl phosphite)titanate, tetra(2,2-diallyloxymethyl-1-butyl)bis(ditridecyl)phosphite titanate, bis(dioctyl pyrophosphate)oxyacetate titanate, bis(dioctyl pyrophosphate)ethylene titanate and the like may be cited. These are used alone or as a combination of two or more.

The spherical silica particles in which each surface is coated with such an organic silane compound or organic titanium compound are prepared, for example, in the following manner. That is, by using the aforementioned organic silane compound or organic titanium compound, spherical silica particles surface-coated with the aforementioned compound are prepared making use of a conventionally known method such as a steam atomization, wet method or the like inorganic filler treatment. They can be also obtained by a method in which surface treatment is effected by dissolving in an alcohol aqueous solution or a solvent.

It is desirable that blending amount of the aforementioned inorganic filer (component C) is set within a range of from 10 to 80% by weight based on the whole liquid epoxy resin composition, particularly preferably from 30 to 70% by weight. That is, this is because its effect on the reduction of coefficient of linear expansion of cured body of the liquid epoxy resin composition becomes small in some cases when the blending amount is less than 10% by weight, and there is a tendency to increase viscosity of the liquid epoxy resin composition when it exceeds 80% by weight.

The organic additive (component D) to be used together with the aforementioned liquid epoxy resin (component A), aromatic diamine curing agent (component B) and inorganic filler (component C) does not have compatibility with the aforementioned liquid epoxy resin (component A) and takes a domain structure throaty its melting by its curing and heat treatments, and for example, a spherical thermoplastic resin particle, a spherical crosslinked resin particle and the like are used. These are used alone or as a combination of two or more.

As the aforementioned spherical thermoplastic resin particles, particles of a polyacrylic resin, a polyether sulfone resin, an ethylene-vinyl acetate copolymer, a polyamide resin, a butadiene-styrene copolymer and the like can be exemplified. These are used alone or as a combination of two or more. Also, as the aforementioned spherical thermoplastic resin particles, those which have an average particle diameter of 10 μm are preferably used, and those having an average particle diameter of from 1 to 5 μm are particularly preferably used. In this connection, the aforementioned average particle diameter can be measured, for example, using a laser diffraction scattering type particle size distribution analyzer in the same manner as described in the foregoing.

Among the aforementioned spherical thermoplastic resin particles, spherical polymethyl methacrylate particles are particularly preferably used, of which spherical polymethyl methacrylate particles having a weight average molecular weight of 100,000 or more are further preferably used and spherical polymethyl methacrylate particles having a weight average molecular weight of from 100,000 to 5,000,000 are particularly preferably used. In this connection, upper limit of the aforementioned weight average molecular weight is generally 10,000,000.

As the aforementioned spherical polymethyl methacrylate particles, epoxy group-containing polymethyl methacrylate particles, carboxy group-containing polymethyl methacrylate particles, polymethyl methacrylate-polyacrylate copolymer particles and the like are also included therein.

Also, as the aforementioned spherical crosslinked resin particles, spherical crosslinked polymethyl methacrylate particles are used particularly preferably. More preferably, spherical crosslinked polymethyl methacrylate particles having a glass transition temperature of 100° C. or more are used. Thus, when the aforementioned spherical crosslinked polymethyl methacrylate particles having a glass transition temperature of 100° C. or more are used, it becomes possible to set the encapsulation temperature to such a higher level that an effect to shorten the encapsulation time at a low viscosity can be obtained. In this connection, the aforementioned glass transition temperature is a value measured by a thermomechanical analysis (TMA) device.

Blending amount of such an organic additive (component D) is not particularly limited with the proviso that the effect of the present invention can be obtained, but it is desirable to set it to a range of from 2 to 20% by weight based on the whole liquid epoxy resin composition, particularly preferably from 3 to 15% by weight. That is, this is because its effect to improve repairability of cured body of the liquid epoxy resin composition cannot be obtained in some cases when the blending amount the organic additive is less than 2% by weight, and there is a tendency to increase viscosity of the liquid epoxy resin composition when it exceeds 20% by weight.

In addition, other than the aforementioned respective components, a reactive diluent can also be blended optionally with the aim of attaining viscosity reduction and the like, but as described in the foregoing on the prepolymer, this reactive diluent sometimes contains volatile low boiling point compounds, so that when this is used, it is desirable to remove in advance the volatile vaporizable low boiling point compounds which cause generation of voids in the filling resin layer at a predetermined curing temperature of a liquid epoxy resin composition as the underfill resin. In addition, when the reactive diluent itself is volatile, voids are apt to generate in the filling resin layer at a predetermined curing temperature of a liquid epoxy resin composition as the underfill resin, so that use of such a reactive diluent is limited.

Examples of the aforementioned reactive diluent include n-butyl glycidyl ether, allyl glycidyl ether, 2-ethylhexyl glycidyl ether, styrene oxide, phenyl glycidyl ether, cresyl glycidyl ether, lauryl glycidyl ether, p-sec-butylphenyl glycidyl ether, nonylphenyl glycidyl ether, glycidyl ether of carbinol, glycidyl methacrylate, vinylcyclohexene monoepoxide, α-pinene oxide, glycidyl ether of a tertiary carboxylic acid, diglycidyl ether, glycidyl ether of (poly)ethylene glycol, glycidyl ether of (poly)propylene glycol, propylene oxide addition product of bisphenol A, a partial addition product of bisphenol A type epoxy resin and polymerized fatty acid, polyglycidyl ether of a polymerized fatty acid, diglycidyl ether of butanediol, vinylcyclohexene dioxide, neopentyl glycol diglycidyl ether, diglycidyl aniline, trimethylolpropane diglycidyl ether, trimethylolpropane triglycidyl ether, glycerol diglycidyl ether, glycerol triglycidyl ether and the like can be cited. These are used alone or as a combination of two or more.

Also, in addition to the aforementioned respective components, antimony trioxide, antimony pentoxide, brominated epoxy resin or the like flame retardant or flame retardant auxiliary; silicone or the like low stress providing agent; a coloring agent and the like may be optionally contained in the liquid epoxy resin composition of the present invention within such a range that the gist of the present invention is not spoiled.

The liquid epoxy resin composition of the present invention can be produced, for example, in the following manner. That is, the one-component non-solvent liquid epoxy resin composition of interest can be produced by formulating predetermined amounts of respective components of the aforementioned liquid epoxy resin (component A), aromatic diamine curing agent (component B), inorganic filler (component C), organic additive (component D), and a hardening accelerator and the like as occasion demands, mixing and dispersing them under a high shearing force of triple roll, homo-mixer or the like, and carrying out degassing under a reduced pressure as occasion demands. Alternatively, when a prepolymer of the aforementioned liquid epoxy resin (component A), particularly a multifunctional aliphatic epoxy resin, with at least one of an aromatic diamine represented by the aforementioned general formula (1) and derivatives thereof or at least one of a fluorine-containing aromatic diamine represented by the aforementioned general formula (2) and derivatives thereof is used, these components are subjected to a preliminary reaction as described in the foregoing. Subsequently, this prepolymer is blended with predetermined amounts of other components, and then the one-component non-solvent liquid epoxy resin composition of interest can be produced in the same manner as in the above.

Resin-filling of the gap between a semiconductor part (e.g., a flip chip or the like semiconductor element or a semiconductor package) and a wiring circuit substrate is carried out, for example, in the following manner. Thai is, a semiconductor part having electrode parts for connection (solder bump) is solder metal-connected in advance with a wiring circuit substrate equipped with electrode parts for connection (solder pad) facing the aforementioned solder bump. Subsequently, the gap between the aforementioned semiconductor part and wiring circuit substrate is resin-filled by filling it with a one-component non-solvent liquid epoxy resin composition making use of capillary phenomenon and thermosetting the composition to effect formation of a filling resin layer.

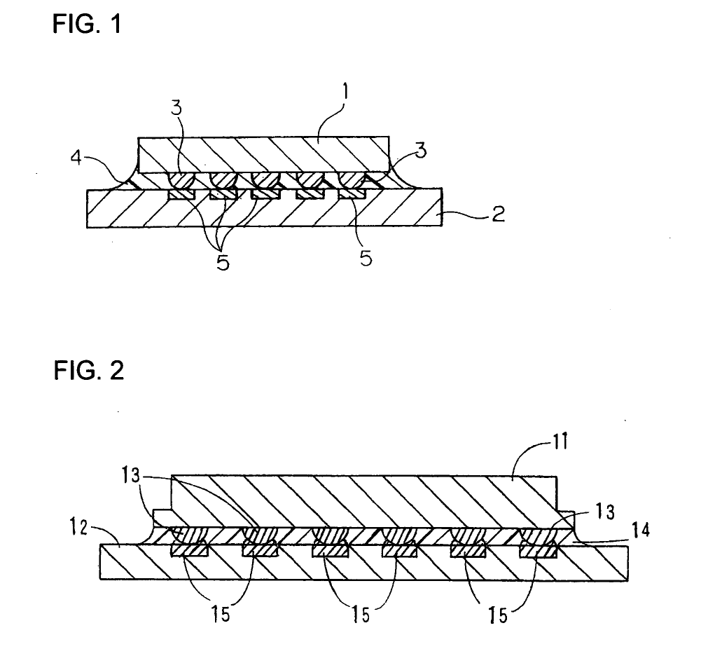

In this manner, for example, when the semiconductor part is a semiconductor element (flip chip), an electronic part device is produced as shown in FIG. 1, in which the semiconductor element (flip chip) 1 is loaded on the wiring circuit substrate 2 under such a condition that the electrode part for connection (solder bump) 3 arranged on the semiconductor element 1 is facing with the electrode part for connection (solder pad) 5 arranged on the wiring circuit substrate 2, and the gap between the aforementioned wiring circuit substrate 2 and semiconductor element (flip chip) 1 is resin-filled with the filling resin layer 4 comprising the aforementioned liquid epoxy resin composition.

On the other hand, for example, when the semiconductor part is a semiconductor device (semiconductor package), an electronic part device is produced as shown in FIG. 2, in which the semiconductor package 11 is loaded on the wiring circuit substrate 12 under such a condition that the electrode part for connection (solder bump) 13 arranged on the semiconductor package 11 is facing with the electrode part for connection (solder pad) 15 arranged on the wiring circuit substrate 12, and the gap between the aforementioned wiring circuit substrate 12 and semiconductor package 11 is resin-filled with the filling resin layer 14 comprising the aforementioned liquid epoxy resin composition.

When the gap between the aforementioned semiconductor element (flip chip) 1 and wiring circuit substrate 2, or the gap between the semiconductor package 11 and wiring circuit substrate 12, is filled with a liquid epoxy resin composition, the liquid epoxy resin composition is firstly packed in a syringe, and then the liquid epoxy resin composition is applied to an end of the aforementioned semiconductor element (flip chip) 1, or an end of the aforementioned semiconductor package 11, by extruding the liquid epoxy resin composition from the needle and filled making use of capillary phenomenon. In carrying out this filling making use of capillary phenomenon, the liquid viscosity is reduced when resin-filled on a hot plate heated to approximately from 60 to 120° C., so that it becomes possible to carry out its packing and filling more easily. In addition, the packing and filling become further more easy when a slope is given to the aforementioned wiring circuit substrate 2.

When the semiconductor part is a semiconductor element (flip chip) 1, the inter-gap distance between the semiconductor element (flip chip) 1 and the wiring circuit substrate 2 of the electronic parts device obtained in this manner is generally approximately from 30 to 300 μm.

Also, when the semiconductor part is a semiconductor package 11, the inter-gap distance between the semiconductor package 11 and the wiring circuit substrate 12 is generally approximately from 200 to 300 μm.

The cured material of the epoxy resin composition in the resin-filled part of the electronic parts device obtained in this manner is swelled by a specific organic solvent to cause reduction of adhesion strength even after the hardening, so that the electronic parts device can be repaired.

As the aforementioned specific organic solvent, a ketone solvent, a glycol di-ether solvent, a nitrogen-containing solvent and the like are desirable. These are used alone or as a combination of two or more.

As the aforementioned ketone solvent, acetophenone, isophorone, ethyl-n-butyl ketone, diisobutyl ketone, diethyl ketone, cyclohexyl ketone, di-n-propyl ketone, methyl oxide, methyl-n-amyl ketone, methyl isobutyl ketone, methyl ethyl ketone, methylcyclohexanone, methyl-n-heptyl ketone, phorone and the like can be exemplified. These are used alone or as a combination of two or more.

As the aforementioned glycol di-ether solvent, ethylene glycol diethyl ether, ethylene glycol dibutyl ether, ethylene glycol dimethyl ether, diethylene glycol ethylmethyl ether, diethylene glycol diethyl ether, diethylene glycol dibutyl ether, diethylene glycol dimethyl ether, triethylene glycol dimethyl ether and the like can be exemplified. These are used alone or as a combination of two or more.

As the aforementioned nitrogen-containing solvent, N,N′-dimethylformamide, N,N′-dimethylacetamide, N-methyl-2-pyrrolidone, N,N′-dimethyl sulfoxide, hexamethyl phosphor triamide and the like may be exemplified. These are used alone or as a combination of two or more.

Regarding the aforementioned electronic parts device repairing method, a semiconductor part (flip chip or the like semiconductor element or semiconductor package) is removed, for example by heating the part to be repaired of the aforementioned semiconductor part or wiring circuit substrate using a hot plate or the like. Regarding the heating temperature in this case, by heating at a temperature higher than the glass transition temperature of the cured material of the liquid epoxy resin composition of the present invention, by a factor of about +50° C. or more, and also by heating at a temperature of higher than the melting point of the solder or the like joining metal, both of them (semiconductor part and wiring circuit substrate) can be easily peeled off under such a condition that the cured material causes cohesive failure or is adhered to one of them. Thereafter, the wiring circuit substrate and mounted part can be reused, when the aforementioned organic solvent is directly applied or absorbent cotton is impregnated with the aforementioned organic solvent and contacted with residual parts of the cured material of the liquid epoxy resin composition of the wiring circuit substrate at room temperature, more preferably at its glass transition temperature or more, and then the residues are removed by confirming swelling of the cured material. On the other hand, regarding the semiconductor part to which residues of the cured material of the liquid epoxy resin composition are adhered, the semiconductor part can be reused by soaking it at room temperature in the aforementioned organic solvent which is put into a proper container, and removing the thus swelled cured material.

Alternatively, though it requires long hours of treatment, the semiconductor part can also be detached from the wiring circuit substrate, by directly applying the aforementioned organic solvent to the whole part to be repaired of the aforementioned wiring circuit substrate, or covering it with absorbent cotton impregnated with the organic solvent, to effect gradual permeation of the organic solvent from the edge of the semiconductor part, and thereby effecting swelling of the cured material and subsequent reduction of strength and adhesion strength of the cured material.

Next, Examples are described together with Comparative Examples.

Firstly, respective components shown in the following were prepared.

[Liquid Epoxy Resin a]

An epoxy resin represented by the following structural formula (a). 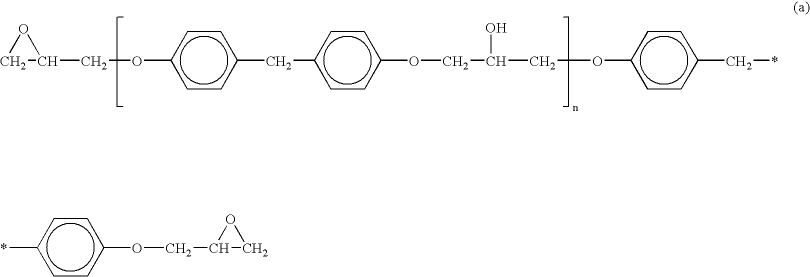
[In the formula (a), n is a positive number of 0 or more. Purity 99%, viscosity 22 dPa·s (25° C.), epoxy equivalent 165 g/eq]
[Liquid Epoxy Resin b]

An aliphatic multifunctional epoxy compound represented by the following structural formula (b). 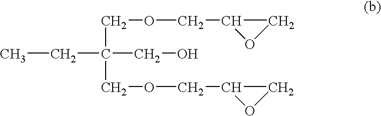
[In the formula (b), viscosity 0.6 dPa·s (25° C.), epoxy equivalent 125 g/eq]
[Curing Agent a]

A fluorine-containing aromatic diamine represented by the following structural formula (c). 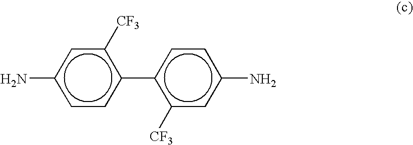
[In the formula (c), melting point 182° C., active hydrogen equivalent 80 g/eq]
[Curing Agent b]

A fluorine-containing aromatic diamine derivative represented by the following structural formula (d) which is obtained by charging 1 mol of 2,2′-ditrifluoromethyl-4,4′-diaminobiphenyl and 0.5 mol of butyl glycidyl ether at that ratio in a reaction container and allowing them to undergo the reaction at 200° C. 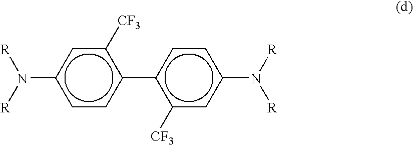
[In the formula (d), 3.5 in average of the 4 R's are hydrogen, and 0.5 in average thereof is —CH₂—CH(OH)CH₂—O—C₄H₉. Also, average active hydrogen equivalent is 110 g/eq.]
[Curing Agent c]

A no-fluorine-containing aromatic diamine represented by the following structural formula (e). 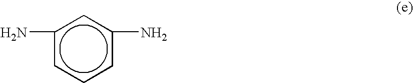
[In the formula (e), melting point 64° C., active hydrogen equivalent 27 g/eq]
[Curing Agent d]

A no-fluorine-containing aromatic diamine derivative represented by the following structural formula (f) which is obtained by charging 1 mol of m-phenylenediamine and 0.5 mol of butyl glycidyl ether at that ratio in a reaction container and allowing them to undergo the reaction at 200° C. 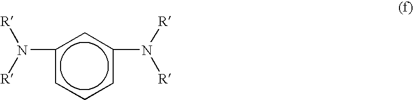
[In the formula (f), 3.5 in average of the 4 R's are hydrogen, and 0.5 in average thereof is —CH₂—CH(OH)CH₂—O—C₄H₉. Also, average active hydrogen equivalent is 49.4 g/eq.]
[Prepolymer a (Fluorine-Containing)]

A prepolymer a which is a starch syrup-like viscous liquid (active hydrogen equivalent 325) which is obtained by allowing 0.5 equivalent (82.5 g) of the aforementioned epoxy resin represented by the structural formula (a) to react with 1 active hydrogen equivalent (80 g) of the aforementioned fluorine-containing aromatic diamine represented by the structural formula (c) at 150° C. for 15 minutes and then cooled.

[Prepolymer b (Fluorine-Containing)]

A prepolymer b (viscosity 190 dpa·s) which is obtained by charging 1 mole of the aforementioned fluorine-containing aromatic diamine derivative represented by the structural formula (d) and 1.75 moles of the aforementioned aliphatic multifunctional epoxy compound represented by the structural formula (b) in a reaction container, and allowing them to undergo the reaction at 100° C. for 2 minutes.

[Inorganic Filler a]

A product prepared by surface-treating the surface of spherical silica particles using 3-aminopropyltriethoxysilane by a steam atomizing method (maximum particle diameter 6 μm, average particle diameter 2 μm, specific surface area 2.1 m²/g)

[Inorganic Filler b]

A product prepared by surface-treating the surface of spherical silica particles using isopropyltriisostearoyl titanate (an organic titanium compound) by a steam atomizing method (maximum particle diameter 6 μm, average particle diameter 2 μm, specific surface area 2.1 m²/g).

[Organic Additive a1]

Spherical polymethyl methacrylate particles (average particle diameter 4 μm, maximum particle diameter 10 μm, weight average molecular weight 3,000,000).

[Organic Additive a2]

Spherical polymethyl methacrylate particles (average particle diameter 3.3 μm, maximum particle diameter 20 μm, weight average molecular weight 1,750,000).

[Organic Additive b1]

Spherical polymethyl methacrylate particles (average particle diameter 4 μm, maximum particle diameter 10 μm, weight average molecular weight 400,000).

[Organic Additive b2]

Spherical polymethyl methacrylate particles (average particle diameter 3.4 μm, maximum particle diameter 20 μm, weight average molecular weight 400,000).

[Organic Additive c]

Spherical polymethyl methacrylate particles (average particle diameter 2.6 μm, maximum particle diameter 5 μm, glass transition temperature 120° C.).

### EXAMPLES

(1) Examples in which Semiconductor Elements (Flip Chips) were used as Semiconductor Parts

### Examples 1 to 18 and Comparative Examples 1 to 3

One-component non-solvent liquid epoxy resin compositions were prepared by blending respective components prepared in the above at the ratios shown in the following Table 1 to Table 4 and uniformly mixing and dispersing them at room temperature (25° C.) using triple roll.

TABLE 1
(part by weight)

| | | Example | | | | | | |
|---|---|---|---|---|---|---|---|---|
| | | 1 | 2 | 3 | 4 | 5 | 6 | 7 |
| Liquid | a | 0.825 | 0.825 | 0.825 | 0.825 | 0.825 | 0.825 | 0.825 |
| epoxy resin | b | 0.625 | 0.625 | 0.625 | 0.625 | 0.625 | 0.625 | 0.625 |
| Curing | a | — | — | — | — | 0.80 | — | — |
| agent | b | 1.10 | 1.10 | 1.10 | 1.10 | — | 1.10 | 1.10 |
| | c | — | — | — | — | — | — | — |
| | d | — | — | — | — | — | — | — |
| Prepolymer | a | — | — | — | — | — | — | — |
| | b | — | — | — | — | — | — | — |
| Inorganic | a | 1.82 | 1.90 | 2.73 | 5.07 | 1.59 | 1.82 | — |
| filler | b | — | — | — | — | — | — | 1.82 |
| Organic | a1 | 0.18 | 0.30 | 0.18 | 0.18 | 0.14 | — | 0.18 |
| Additive | b1 | — | — | — | — | — | 0.18 | — |
| | c | — | — | — | — | — | — | — |

TABLE 2
(part by weight)

| | | Example | | | | | | |
|---|---|---|---|---|---|---|---|---|
| | | 8 | 9 | 10 | 11 | 12 | 13 | 14 |
| Liquid | a | 0.825 | 0.825 | 0.825 | 0.825 | 0.825 | 0.825 | 0.825 |
| epoxy resin | b | 0.625 | 0.625 | 0.625 | 0.625 | 0.625 | 0.625 | 0.625 |
| Curing | a | — | — | — | — | — | — | — |
| agent | b | — | — | — | — | — | — | — |
| | c | — | — | — | — | 0.27 | — | — |
| | d | 0.49 | 0.49 | 0.49 | 0.49 | — | 0.49 | 0.49 |
| Prepolymer | a | — | — | — | — | — | — | — |
| | b | — | — | — | — | — | — | — |
| Inorganic | a | 1.03 | 1.90 | 1.54 | 2.86 | 1.22 | 1.03 | — |
| filler | b | — | — | — | — | — | — | 1.03 |
| Organic | a1 | 0.09 | 0.16 | 0.09 | 0.09 | 0.11 | — | 0.09 |
| Additive | b1 | — | — | — | — | — | 0.09 | — |
| | c | — | — | — | — | — | — | — |

TABLE 3
(part by weight)

Example

| | | 15 | 16 | 17 | 18 |
|---|---|---|---|---|---|
| Liquid | a | — | 0.825 | 0.825 | 0.825 |
| epoxy resin | b | 0.625 | — | 0.625 | 0.625 |
| Curing agent | a | — | — | — | — |
| | b | — | — | 1.10 | 1.10 |
| | c | — | — | — | — |
| | d | — | — | — | — |
| Prepolymer | a | 1.625 | — | — | — |
| | b | — | 1.725 | — | — |
| Inorganic | a | 1.61 | 1.82 | 1.82 | 2.73 |
| filler | b | — | — | — | — |
| Organic | a1 | 0.16 | 0.18 | — | — |
| Additive | b1 | — | — | — | — |
| | c | — | — | 0.18 | 0.18 |

TABLE 4
(part by weight)

| | | Comparative Example | | |
|---|---|---|---|---|
| | | 1 | 2 | 3 |
| Liquid | a | 0.825 | 0.825 | 0.825 |
| epoxy resin | b | 0.625 | — | 0.625 |
| Curing agent | a | — | — | — |
| | b | 1.10 | — | — |
| | c | — | — | — |
| | d | — | — | 0.49 |
| Prepolymer | a | — | — | — |
| | b | — | 1.725 | — |
| Inorganic | a | 1.82 | 1.82 | 1.03 |
| filler | b | — | — | — |
| Organic | a1 | — | — | — |
| Additive | b1 | — | — | — |
| | c | — | — | — |

Using the liquid epoxy resin compositions of Examples and Comparative Examples obtained in this manner, their viscosities at 25° C. were measured using an EMD type rotational viscometer, and then each of them was filled in a polypropylene syringe equipped with a needle of 0.56 mm in needle inner diameter.

Thereafter, by allowing to stand at 25° C. under the aforementioned syringe-filled condition, the time until its viscosity has doubled was measured and used as the pot life.

On the other hand, a silicon chip (thickness 370 μm, size 10 mm×10 mm) having 64 Sn-3Ag-0.5Cu solder bump electrodes of 200 μm in diameter was prepared, 63Sn-37Pb solder paste-coated copper wiring pads (substrate-side electrodes) of an FR-4 glass epoxy wiring circuit substrate having a thickness of 1 mm on which 64 copper wiring pads of 300 μm in diameter were opened (substrate-side electrodes) and the aforementioned solder bump electrodes of silicon chip were aligned such that they were facing with each other, the resulting pair was loaded on the substrate, and then this was subjected to solder joining through a heat reflow furnace under a condition of 260° C. for 5 seconds. The void (gap) between the aforementioned silicon chip and circuit substrate was 210 μm.

Subsequently, an electronic part device was prepared by discharging and applying the liquid epoxy resin composition from the needle to a side of the gap between the aforementioned silicon chip (flip chip) and circuit substrate by applying air pressure to the syringe filled with the aforementioned liquid epoxy resin composition, filling up the liquid epoxy resin composition by capillary phenomenon with heating on a 60° C. hot plate, measuring the period of fill up time, and carrying out resin-filling after completion of the fill up through 4 hours of curing at 150° C.

After completion of the curing and subsequent slow cooling, the presence or absence of voids in the filling resin layer where the gap between the wiring circuit substrate and semiconductor element was filled and sealed was observed by an ultrasonic flow detector. Thereafter, a case in which voids were not observed was evaluated as ◯, and a case in which 1 or 2 voids was observed as Δ, and a case in which the number of voids of more than that was observed as X.

Using each of the respective electronic parts devices obtained in this manner, defect percentage in conductivity and repairability were measured and evaluated in accordance with the methods shown in the following. The results are shown in the following Table 5 to Table 8, together with those of the measurement of characteristics of the aforementioned liquid epoxy resin compositions.

[Defect Percentage in Conductivity]

Defect percentage in conductivity just after resin-filling of the aforementioned electronic parts device was measured. Thereafter, the aforementioned electronic parts device was subjected to a temperature cycle test of −40° C./10 minutes [symbol] 125° C./10 minutes using a thermal shock tester, thereby examining electrical conductivity after 1000 cycles, and defect percentage in conductivity (%) was calculated for all of the 64 copper wiring pads (substrate-side electrodes) of the aforementioned glass epoxy wiring circuit substrate.

[Repairability]

After measurement of the aforementioned defect percentage in conductivity, the silicon chip was peeled from the aforementioned electronic parts device on a hot plate heated to 200° C. and returned to room temperature, and absorbent cotton impregnated with an equivalent amount mixed solvent of N,N′-dimethylformamide and diethylene glycol dimethyl ether was allowed to stand still on the residual parts of the cured material of the epoxy resin composition remaining on the connecting part thereof and allowed to stand at room temperature (22° C.) for 1 hour. Thereafter, peeling of the cured material of epoxy resin composition was carried out by removing this absorbent cotton and thoroughly wiping the rest with methanol, and after supply of solder paste to the pad parts of the wiring circuit substrate and subsequent solder fusion, electrical conductivity of the strippable electronic parts device was again examined by loading the silicon chip on the wiring circuit substrate in the same manner as described in the foregoing. Thereafter, evaluation of repair (rework) ability was carried out by resin-filling it in the same manner as described in the foregoing.

In this connection, a case in which the cured material of epoxy resin composition is completely strippable and electrical connection is perfect was expressed as ⊚, and a case in which the cured material can be stripped but slightly remaining, and the electrical connection is perfect as ◯, a case in which the cured material can be stripped but slightly remaining, but the electrical connection is imperfect as Δ, and a case in which the cured material of epoxy resin composition can hardly be stripped and the electrical connection is imperfect as X.

TABLE 5

| | Example | | | | | | |
|---|---|---|---|---|---|---|---|
| | 1 | 2 | 3 | 4 | 5 | 6 | 7 |
| Viscosity (at 25° C.) | 300 | 800 | 600 | 1400 | 200 | 280 | 305 |
| (dPa · s) | | | | | | | |
| Pot life (at 25° C.) | 36 | 36 | 34 | 35 | 120 | 32 | 35 |
| (hours) | | | | | | | |
| Filling time (minutes) | 2 | 3 | 3 | 6 | 1.5 | 2 | 2.5 |
| Defect percentage in | 0 | 0 | 0 | 0 | 0 | 0 | 0 |
| conductivity (%) | | | | | | | |
| Void | ◯ | ◯ | ◯ | ◯ | ◯ | ◯ | ◯ |
| Repairability (22° C.) | ⊚ | ⊚ | ◯ | ◯ | ◯ | ◯ | ⊚ |

TABLE 6

| | Example | | | | | | |
|---|---|---|---|---|---|---|---|
| | 8 | 9 | 10 | 11 | 12 | 13 | 14 |
| Viscosity (at 25° C.) | 120 | 350 | 300 | 900 | 80 | 115 | 130 |
| (dPa · s) | | | | | | | |
| Pot life (at 25° C.) | 4 | 4 | 4 | 3 | 5 | 4 | 4 |
| (hours) | | | | | | | |
| Filling time (minutes) | 2 | 3 | 3 | 6 | 1.5 | 2 | 2.5 |
| Defect percentage in | 0 | 0 | 0 | 0 | 0 | 0 | 0 |
| conductivity (%) | | | | | | | |
| Void | ◯ | ◯ | ◯ | ◯ | ◯ | ◯ | ◯ |
| Repairability (22° C.) | ◯ | ◯ | ◯ | ◯ | ◯ | ◯ | ◯ |

TABLE 7

| | Example | | | |
|---|---|---|---|---|
| | 15 | 16 | 17 | 18 |
| Viscosity (at 25° C.) (dPa · s) | 720 | 440 | 305 | 610 |
| Pot life (at 25° C.) (hours) | 7 | 24 | 35 | 34 |
| Filling time (minutes) | 4 | 1.5 | 2 | 2.5 |
| Defect percentage in conductivity (%) | 0 | 0 | 0 | 0 |
| Void | ◯ | ◯ | ◯ | ◯ |
| Repairability (22° C.) | ◯ | ⊚ | ⊚ | ◯ |

TABLE 8

| | Comparative Example | | |
|---|---|---|---|
| | 1 | 2 | 3 |
| Viscosity (at 25° C.) (dPa · s) | 250 | 370 | 90 |
| Pot life (at 25° C.) (hours) | 37 | 24 | 4 |
| Filling time (minutes) | 1.5 | 2.5 | 1.5 |
| Defect percentage in conductivity (%) | 0 | 0 | 0 |
| Void | ◯ | ◯ | ◯ |
| Repairability (22° C.) | X | Δ | X |

As a result of the above, it can be understood that all of the liquid epoxy resin compositions of Examples are excellent as void-less one-component non-solvent liquid epoxy resin compositions because of their long pot life and low viscosity. In addition, it is evident that the formed filling resin layer of the prepared electronic parts device has no void generation and conductivity failure and is also excellent in repairability. Contrary to this, the liquid epoxy resin compositions of Comparative Examples showed no conductivity failure and are void-less, but are inferior in repairability in comparison with the products of Examples.

(2) Examples in which Semiconductor Devices (Semiconductor Packages) were used as Semiconductor Parts

### Examples 19 to 29 and Comparative Examples 4 to 6

One-component non-solvent liquid epoxy resin compositions were prepared by blending respective components prepared in the above at the ratios shown in the following Table 9 to Table 11 and uniformly mixing and dispersing them at room temperature (25° C.) using triple roll.

TABLE 9
(part by weight)

| | | Example | | | | | | |
|---|---|---|---|---|---|---|---|---|
| | | 19 | 20 | 21 | 22 | 23 | 24 | 25 |
| Liquid | a | 0.825 | 0.825 | 0.825 | 0.825 | 0.825 | 0.825 | 0.825 |
| epoxy resin | b | 0.625 | 0.625 | 0.625 | 0.625 | 0.625 | 0.625 | 0.625 |
| Curing | a | — | — | — | — | 0.80 | — | — |
| agent | b | 1.10 | 1.10 | 1.10 | 1.10 | — | 1.10 | 1.10 |
| Prepolymer | a | — | — | — | — | — | — | — |
| | b | — | — | — | — | — | — | — |
| Inorganic | a | 1.82 | 1.90 | 2.73 | 5.07 | 1.69 | 1.82 | — |
| filler | b | — | — | — | — | — | — | 1.82 |
| Organic | a2 | 0.18 | 0.30 | 0.18 | 0.18 | 0.14 | — | 0.18 |
| Additive | b2 | — | — | — | — | — | 0.18 | — |
| agent | c | — | — | — | — | — | — | — |

TABLE 10
(part by weight)

Example

| | | 26 | 27 | 28 | 29 |
|---|---|---|---|---|---|
| Liquid | a | — | 0.825 | 0.825 | 0.825 |
| epoxy resin | b | 0.625 | — | 0.625 | 0.625 |
| Curing | a | — | — | — | — |
| agent | b | — | — | 1.10 | 1.10 |
| Prepolymer | a | 1.625 | — | — | — |
| | b | — | 1.725 | — | — |
| Inorganic | a | 1.61 | 1.82 | 1.82 | 2.73 |
| filler | b | — | — | — | — |
| Organic | a2 | 0.16 | 0.18 | — | — |
| Additive | b2 | — | — | — | — |
| | c | — | — | 0.18 | 0.18 |

TABLE 11
(part by weight)

| | | Comparative Example | | |
|---|---|---|---|---|
| | | 4 | 5 | 6 |
| Liquid | a | 0.825 | 0.825 | 0.825 |
| epoxy resin | b | 0.625 | — | 0.625 |
| Curing agent | a | — | — | 0.80 |
| | b | 1.10 | — | — |
| Prepolymer | a | — | — | — |
| | b | — | 1.725 | — |
| Inorganic | a | 1.82 | 1.82 | 1.62 |
| filler | b | — | — | — |
| Organic | a2 | — | — | — |
| Additive | b2 | — | — | — |
| | c | — | — | — |

Using the liquid epoxy resin compositions of Examples and Comparative Examples obtained in this manner, their viscosities at 25° C. were measured using an EMD type rotational viscometer, and then each of them was filled in a polypropylene syringe equipped with a needle of 0.56 mm in needle inner diameter.

Thereafter, by allowing to stand at 25° C. under the aforementioned syringe-filled condition, the time until its viscosity has doubled was measured and used as the pot life.

On the other hand, an CSP package (package height 1 mm, size 10 mm×10 mm) having 64 Sn-3Ag-0.5Cu solder bump electrodes of 200 μm in diameter was prepared, 63Sn-37Pb solder paste-coated copper wiring pads (substrate-side electrodes) of an FR-4 glass epoxy wiring circuit substrate having a thickness of 1 mm on which 64 copper wiring pads of 300 μm in diameter were opened (substrate-side electrodes) and the aforementioned solder bump electrodes of CSP package were aligned such that they were facing with each other, the resulting pair was loaded on the substrate, and then this was subjected to solder joining through a heat reflow furnace under a condition of 260° C. for 5 seconds. The void (gap) between the aforementioned CSP package and circuit substrate was 250 μm.

Subsequently, an electronic part device was prepared by discharging and applying the liquid epoxy resin composition from the needle to a side of the gap between the aforementioned CSP package and circuit substrate by applying air pressure to the syringe filled with the aforementioned liquid epoxy resin composition, filling up the liquid epoxy resin composition by capillary phenomenon with heating on a 60° C. hot plate, measuring the period of fill up time, and carrying out resin-filling after completion of the filling up through 4 hours of curing at 150° C.

After completion of the curing and subsequent slow cooling, the presence or absence of voids in the filling resin layer where the gap between the wiring circuit substrate and CSP package was filled and sealed was observed by an ultrasonic flow detector. Thereafter, a case in which voids were not observed was evaluated as ◯, and a case in which 1 or 2 voids was observed as Δ, and a case in which the number of voids of more than that was observed as X.

Using each of the respective electronic parts devices obtained in this manner, defect percentage in conductivity and repairability were measured and evaluated in accordance with the methods shown in the following. The results are shown in the following Table 12 to Table 14, together with those of the measurement of characteristics of the aforementioned liquid epoxy resin compositions.

[Drop and Impact Resistance Test]

Each of the substrate termini after resin-filling of the aforementioned electronic parts device was equipped with a 100 g weight and dropped from a height of 1.2 m on a wooden floor, and the frequency of generating conductivity failure was calculated on the substrate to which the aforementioned electronic parts device was attached.

[Defect Percentage in Conductivity]

Defect percentage in conductivity just after resin-filling of the aforementioned electronic parts device was measured. Thereafter, the aforementioned electronic parts device was subjected to a temperature cycle test of −40° C./10 minutes [symbol] 125° C./10 minutes using a thermal shock tester, thereby examining electrical conductivity after 1000 cycles, and defect percentage in conductivity (%) was calculated for all of the 64 copper wiring pads (substrate-side electrodes) of the aforementioned glass epoxy wiring circuit substrate.

[Repairability]

After measurement of the aforementioned defect percentage in conductivity, the CSP package was peeled from the aforementioned electronic parts device on a hot plate heated to 200° C. and returned to room temperature, and absorbent cotton impregnated with an equivalent amount mixed solvent of N,N′-dimethylformamide and diethylene glycol dimethyl ether was allowed to stand still on the residual parts of the cured material of the epoxy resin composition remaining on the connecting part thereof and allowed to stand at room temperature (22° C.) for 1 hour. Thereafter, peeling of the cured material of epoxy resin composition was carried out by removing this absorbent cotton and thoroughly wiping the rest with methanol, and after supply of solder paste to the pad parts of the wiring circuit substrate and subsequent solder fusion, electrical conductivity of the strippable electronic parts device was again examined by loading the CSP package on the wiring circuit substrate in the same manner as described in the foregoing. Thereafter, evaluation of repair (rework) ability was carried out by resin-filling it in the same manner as described in the foregoing.

In this connection, a case in which the cured material of epoxy resin composition is completely strippable and electrical connection is perfect was expressed as ⊚, and a case in which the cured material can be stripped but slightly remaining, and the electrical connection is perfect as ◯, a case in which the cured material can be stripped but slightly remaining, but the electrical connection is imperfect as Δ, and a case in which the cured material of epoxy resin composition can hardly be stripped and the electrical connection is imperfect as X.

TABLE 12

| | Example | | | | | | |
|---|---|---|---|---|---|---|---|
| | 19 | 20 | 21 | 22 | 23 | 24 | 25 |
| Viscosity (at | 300 | 800 | 600 | 1400 | 200 | 280 | 305 |
| 25° C.) (dPa · s) | | | | | | | |
| Pot life (at | 36 | 36 | 34 | 35 | 120 | 32 | 35 |
| 25° C.) (hours) | | | | | | | |
| Filling time | 1 | 1.5 | 1.5 | 3 | 0.8 | 1 | 1.3 |
| (minutes) | | | | | | | |
| Drop and | 5000 | 5000 | 5000 | 5000 | 5000 | 5000 | 5000 |
| impact | times | times | times | times | times | times | times |
| resistance | or | or | or | or | or | or | or |
| test (times) | more | more | more | more | more | more | more |
| Defect | 0 | 0 | 0 | 0 | 0 | 0 | 0 |
| percentage in | | | | | | | |
| conductivity | | | | | | | |
| (%) | | | | | | | |
| Void | ◯ | ◯ | ◯ | ◯ | ◯ | ◯ | ◯ |
| Repairability | ⊚ | ⊚ | ◯ | ◯ | ◯ | ◯ | ⊚ |
| (22° C.) | | | | | | | |

TABLE 13

| | Example | | | |
|---|---|---|---|---|
| | 26 | 27 | 28 | 29 |
| Viscosity (at 25° C.) | 120 | 350 | 305 | 610 |
| (dPa · s) | | | | |
| Pot life (at 25° C.) | 4 | 4 | 35 | 34 |
| (hours) | | | | |
| Filling time (minutes) | 1 | 1.5 | 1 | 1.5 |
| Drop and impact | 5000 | 5000 | 5000 | 5000 |
| resistance test (times) | times or | times or | times or | times or |
| | more | more | more | more |
| Defect percentage in | 0 | 0 | 0 | 0 |
| conductivity (%) | | | | |
| Void | ◯ | ◯ | ◯ | ◯ |
| Repairability (22° C.) | ◯ | ◯ | ◯ | ◯ |

TABLE 14

| | Comparative Example | | |
|---|---|---|---|
| | 4 | 5 | 6 |
| Viscosity (at 25° C.) | 250 | 370 | 180 |
| (dPa · s) | | | |
| Pot life (at 25° C.) | 37 | 24 | 125 |
| (hours) | | | |
| Filling time (minutes) | 0.8 | 1.3 | 0.7 |
| Drop and impact | 5000 times | 5000 times | 5000 times |
| resistance test (times) | or more | or more | or more |
| Defect percentage in | 0 | 0 | 0 |
| conductivity (%) | | | |
| Void | ◯ | ◯ | ◯ |
| Repairability (22° C.) | X | Δ | X |

As a result of the above, it can be understood that all of the liquid epoxy resin compositions of Examples are excellent as void-less one-component non-solvent liquid epoxy resin compositions because of their long pot life and low viscosity. In addition, it is evident that the formed filling resin layer of the prepared electronic parts device has no void generation and conductivity failure, the result of its drop and impact resistance test is also good, and it is also excellent in repairability. Contrary to this, the liquid epoxy resin compositions of Comparative Examples showed no conductivity failure and are void-less, but are inferior in repairability in comparison with the products of Examples.

While the invention has been describe in detail and with reference to specific embodiments thereof, it will be apparent to one skilled in the art that various changes and modifications can be made therein without departing from the spirit and scope of the invention.

This application is based on a Japanese patent application filed on May 11, 2004 (Japanese Patent Application No. 2004-141586) and a Japanese patent application filed on Dec. 9, 2004 (Japanese Patent Application No. 2004-357099), the entire contents thereof being thereby incorporated by reference.

### INDUSTRIAL APPLICABILITY

The present invention provides a liquid epoxy resin composition which is used in resin-encapsulation by filling the gap between a semiconductor part and a circuit substrate, in a flip chip connecting method in which facing electrodes of a semiconductor part and a circuit substrate are electrically connected via an electrode for connection (bump) of a semiconductor package such as BGA (ball grid array), CSP (chip scale package or chip size package) or the like or a semiconductor part such as a semiconductor element or the like.

1. A liquid epoxy resin composition to be used for filling the gap between a circuit substrate and a semiconductor part of an electronic part device,
wherein said electronic part device comprises a circuit substrate having an electrode part for connection and a semiconductor part having an electrode part for connection and being mounted on the circuit substrate in such a way that the electrode part of the circuit substrate and the electrode part of the semiconductor part are facing each other,
which comprises the following components (A) to (C) and the following component (D):
(A) a liquid epoxy resin, (B) an aromatic diamine curing agent, (C) an inorganic filler, (D) an organic additive.

2. The liquid epoxy resin composition according to claim 1, wherein the aromatic diamine curing agent as the component (B) is at least one of an aromatic diamine represented by the following general formula (1) and derivatives thereof: 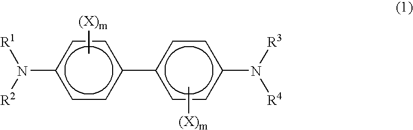
[in the formula (1), X is hydrogen and/or CₙH₂ₙ₊₁ (n is a positive number of from 1 to 10), m is a positive number of from 1 to 4, and R¹ to R⁴ may be the same or different from one another and each is hydrogen or a monovalent organic group].

3. The liquid epoxy resin composition according to claim 1, wherein the aromatic diamine curing agent as the component (B) is at least one of a fluorine-containing aromatic diamine represented by the following general formula (2) and derivatives thereof 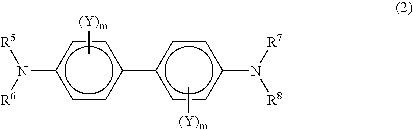
[in the formula (2), Y is fluorine and/or CₙF₂ₙ₊₁ (n is a positive number of from 1 to 10), m is a positive number of from 1 to 4, and R ⁵to R⁸ may be the same or different from one another and each is hydrogen or a monovalent organic group].

4. The liquid epoxy resin composition according to claim 1, wherein the aromatic diamine curing agent as the component (B) is a reaction product of a monoepoxy compound containing one epoxy group in one molecule with 2,2′-ditrifluoromethyl-4,4′-diaminobiphenyl.

5. The liquid epoxy resin composition according to claim 4, wherein the monoepoxy compound containing one epoxy group in one molecule is at least one compound selected from the group consisting of n-butyl glycidyl ether, allyl glycidyl ether, 2-ethylhexyl glycidyl ether, styrene oxide, phenyl glycidyl ether, cresyl glycidyl ether, lauryl glycidyl ether, p-sec-butylphenyl glycidyl ether, nonylphenyl glycidyl ether, glycidyl ether of carbinol, glycidyl methacrylate, vinylcyclohexene monoepoxide and α-pinene oxide.

6. The liquid epoxy resin composition according to claim 2, which comprises a prepolymer prepared by allowing at least one of an aromatic diamine represented by the general formula (1) and derivatives thereof to react with a liquid epoxy resin as the component (A).

7. The liquid epoxy resin composition according to claim 3, which comprises a prepolymer prepared by allowing at least one of a fluorine-containing aromatic diamine represented by the general formula (2) and derivatives thereof to react with a liquid epoxy resin as the component (A).

8. The liquid epoxy resin composition according to claim 1, wherein the inorganic filler as the component (C) is a spherical silica powder having an average particle diameter of 10 μm or less.

9. The liquid epoxy resin composition according to claim 1, wherein the inorganic filler as the component (C) is a spherical silica powder having an average particle diameter of 10 μm or less, wherein the surface thereof is coated with an organic silane compound represented by the following general formula (3)
(α¹—O)ₐ—Si—(β¹)_{b} (3)
[in the formula (3), α¹ is a monovalent organic group other than hydrogen, β¹ is a monovalent organic group containing at least one amino group, epoxy group, vinyl group, styryl group, methacryloxy group or ureido group, and a and b are a+b=4 and each is a positive number of 1 to 3].

10. The liquid epoxy resin composition according to claim 9, wherein the organic silane compound represented by the general formula (3) is an organic silane compound represented by the following general formula (4)
(α¹—O)₃—Si—γ—NH₂ (4)
[in the formula (4), α¹ is a monovalent organic group other than hydrogen, and γ is a divalent organic group].

11. The liquid epoxy resin composition according to claim 1, wherein the inorganic filler as the component (C) is a spherical silica powder having an average particle diameter of 10 μm or less, wherein the surface thereof is coated with an organic titanium compound represented by the following general formula (5)
(α¹—O)ₐ—Ti—(β¹)_{b} (5)
[in the formula (5), α¹ is a monovalent organic group other than hydrogen, β¹ is a monovalent organic group containing at least one amino group, epoxy group, vinyl group, styryl group, methacryloxy group or ureido group, and a and b are a+b=4 and each is a positive number of 1 to 3].

12. The liquid epoxy resin composition according to claim 1, wherein the organic additive as the component (D) is at least one of a spherical thermoplastic resin particle having an average particle diameter of 10 μm or less and a spherical crosslinked resin particle having an average particle diameter of 10 μm or less.

13. The liquid epoxy resin composition according to claim 12, wherein at least one of the spherical thermoplastic resin particle and spherical crosslinked resin particle is a spherical polymethyl methacrylate particle.

14. The liquid epoxy resin composition according to claim 13, wherein weight average molecular weight of the spherical polymethyl methacrylate particle is within the range of from 100,000 to 5,000,000.

15. The liquid epoxy resin composition according to claim 13, wherein the spherical polymethyl methacrylate particle is a spherical crosslinked polymethyl methacrylate particle having a glass transition temperature of 100° C. or more.

16. The liquid epoxy resin composition according to claim 1, wherein the semiconductor part is a semiconductor element.

17. The liquid epoxy resin composition according to claim 1, wherein the semiconductor part is a semiconductor device.
